(19) United States
(12) Patent Application Publication
(10) Pub. No.: US 2005/0206316 A1
(43) Pub. Date: Sep. 22, 2005

(54) Plasma display panel and method of manufacturing the same

(76) Inventors: Jong-Sang Lee, Suwon-si (KR); Byung-Kwan Song, Suwon-si (KR); Jin-Beyung Lee, Suwon-si (KR); Cheol-Hee Moon, Suwon-si (KR); Chang-Seok Rho, Suwon-si (KR)

Correspondence Address: Robert E. Bushnell;Suite 300, 1522 K Street, N.W., Washington, DC, 20005, US

(21) Appl. No.: 11/040,101

(22) Filed: Jan. 24, 2005

(30) Foreign Application Priority Data
Jan. 30, 2004 (KR) 10-2004-0005967

(51) Int. Cl. H01J 17/49; H01J 9/24

(52) U.S. Cl. 313/582; 313/587; 445/24

(57) ABSTRACT

There is provided a plasma display panel having an improved dielectric layer and a method of manufacturing the plasma display panel. The method of manufacturing the plasma display panel comprises the steps of: forming electrodes in a direction on a substrate; cleaning the substrate on which the electrodes are formed; coating the substrate with dielectric paste; drying the dielectric paste; and firing the dielectric paste and forming a dielectric layer having a single layer. Accordingly, it is possible to form a dielectric layer for a plasma display panel having reduced bubbles and an excellent transmittance.

### CLAIM OF PRIORITY

This application makes reference to, incorporates the same herein, and claims all benefits accruing under 35 U.S.C.§119 from an application for PLASMA DISPLAY PANEL PROVIDED WITH AN IMPROVED DIELECTRIC LAYER AND THE METHOD FOR MANUFACTURING THE SAME earlier filed in the Korean Intellectual Property Office on 30 Jan. 2004 and there duly assigned Serial No. 10-2004-0005967.

### BACKGROUND OF THE INVENTION

1. Field of the Invention

The present invention relates to a plasma display panel and a method of manufacturing the plasma display panel, and more particularly, to a plasma display panel having an improved dielectric layer and a method of manufacturing the plasma display panel.

2. Description of the Related Art

As known well, a plasma display panel (PDP) is a display panel for forming images by exciting a rear substrate with plasma discharge or exciting a fluorescent substance with the plasma discharge. Specifically, the plasma discharge is generated between two electrodes provided in a discharge space of the plasma display panel by applying a predetermined voltage to the two electrodes, and images are formed by exciting a fluorescent layer formed in a predetermined pattern with ultraviolet rays arising from the plasma discharge.

Such a plasma display panel is roughly classified into an AC type PDP, a DC type PDP, and a hybrid type PDP. A conventional plasma display panel comprises a rear substrate, a plurality of address electrodes formed on the rear substrate, a dielectric layer formed on the rear substrate on which the address electrodes have been formed, a plurality of partition walls which is formed on the dielectric layer and which maintains a discharge gap and prevents a crosstalk between cells, and a fluorescent layer formed on the surfaces of the partition walls.

A plurality of display electrodes is formed on a front substrate so as to intersect the plurality of address electrodes formed on the rear substrate perpendicularly thereto with a predetermined gap. A dielectric layer and an MgO protective film are sequentially formed on the display electrodes.

A screen printing method has been conventionally used for forming the dielectric layer of the plasma display panel. The screen printing method is a process of coating the substrate, on which the electrodes are formed, with dielectric paste through a screen mask. It is possible to form all constituent elements of the plasma display panel by using only one printing machine and replacing the screen mask and the paste. In the screen printing method, the dielectric layer is printed by ejecting the dielectric paste through openings of the screen mask while reciprocating a squeezer filled with the dielectric paste over the screen mask. Next, the dielectric layer is completed by drying and firing the printed dielectric layer.

In the above-described screen printing method, since the process must be repeated plural times to obtain the dielectric layer having a desired thickness, bubbles occur between the dielectric layers coated plural times and have a bad influence on a discharge characteristic. In addition, the thickness of the dielectric layer is not uniform due to the repeated processes and thus a dielectric characteristic is varied, thereby deteriorating a brightness characteristic. Since steps can be formed at the edge portions at the time of formation of the dielectric layer, the steps can weaken the adhesiveness between the frit coated on the stepped portions and the substrate, thereby bringing about a problem with occurrence of leakage.

There is a problem that the successive repetition of the dry and firing processes can increase process cost as well as process time. Since the mesh shape of the screen mask is left on the dielectric layer, smoothness of the surface can be deteriorated and the squeezer can be wore. Therefore, it is necessary to frequently replace the squeezer.

### SUMMARY OF THE INVENTION

In order to solve the above-mentioned problems of the screen printing method at the time of forming the dielectric layer on the plasma display panel, the present invention provides a method of manufacturing a plasma display panel capable of more efficiently manufacturing the plasma display panel.

According to an aspect of the present invention, there is provided a method of manufacturing a plasma display panel, the method comprising the steps of: forming electrodes in a direction on a substrate; cleaning the substrate on which the electrodes are formed; coating the substrate with dielectric paste; drying the dielectric paste; and firing the dielectric paste and forming a dielectric layer having a single layer.

In the step of coating the substrate with the dielectric paste, the dielectric paste may be coated using a coater or may be coated in the form of a lamination sheet.

In the step of forming the electrodes, the electrodes may be display electrodes.

In the step of coating the substrate with the dielectric paste, the dielectric paste may contain dielectric powders having an average diameter of 0.7 μm to 2.0 μm.

The step of forming the dielectric layer may include a step of removing a binder by firing the dielectric paste at a temperature of 350° C. to 450° C. for 10 to 30 minutes.

In the step of forming the dielectric layer, the dielectric paste may be baked at a temperature of 550° C. to 580° C. for 10 to 30 minutes.

In the step of forming the electrodes, a plurality of electrode units may be formed in one substrate.

The method according to the present invention may further comprise a step of cutting the substrate into respective plasma display panel units, after performing the step of forming the dielectric layer.

According to another aspect of the present invention, there is provided a plasma display panel comprising: a pair of substrates opposing each other; first electrodes and second electrodes formed on the opposed surfaces of the substrates in directions intersecting each other; and a dielectric layer formed to cover the first electrodes or the second electrodes, wherein the dielectric layer extends to an end of an edge of the substrates. The dielectric layer may have a single layer.

The height of a cross-section of the dielectric layer taken perpendicularly to the extending direction of the electrodes may be constant in the vicinity of one end of the substrate.

The edge portion of the dielectric layer may be formed in a non-stepped shape.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view illustrating discharge cells of a typical plasma display panel;

FIG. 2 is a perspective view illustrating a front substrate of a plasma display panel coated with a dielectric layer according to an embodiment of the present invention;

FIG. 3 is a diagram schematically illustrating a method of manufacturing a plasma display panel according to a first embodiment of the present invention;

FIG. 4 is a diagram schematically illustrating a method of manufacturing a plasma display panel according to a second embodiment of the present invention;

FIG. 5 is a perspective view illustrating the front substrate of the plasma display panel in which a plurality of plasma display panel units are formed in one substrate according to an embodiment of the present invention;

FIGS. 6A and 6B are SEM pictures illustrating cross-sections of a dielectric layer for comparison of an embodiment of the present invention with a conventional comparative example; and

FIGS. 7A to 7C are SEM pictures illustrating cross-sections of a dielectric layer in the vicinity of an electrode portion for comparison of an embodiment of the present invention with a conventional comparative example.

### DETAILED DESCRIPTION OF THE INVENTION

Hereinafter, exemplary embodiments of the present invention will be described in detail with reference to the accompanying drawings.

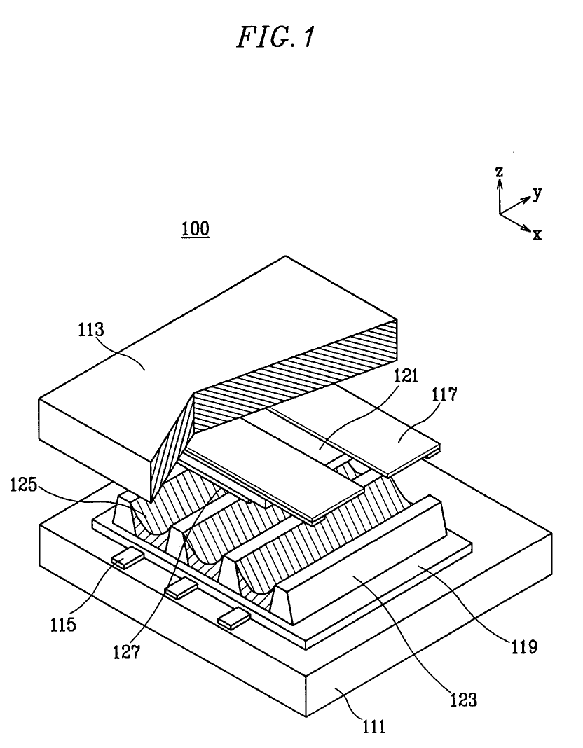

FIG. 1 is an exploded perspective view illustrating discharge cells of a typical AC-type plasma display panel.

Referring to the figure, the typical plasma display panel 100 comprises a rear substrate 111, a plurality of address electrodes 115 formed on the rear substrate 111, a dielectric layer 119 on the rear substrate 111 on which the address electrodes 115 are formed, a plurality of partition walls 123 which is formed on the dielectric layer 119 and which maintains a discharge gap and prevents a crosstalk between cells, and a fluorescent layer 125 formed on the surfaces of the partition walls 123.

A plurality of display electrodes 117 is formed on a front substrate 113 so as to intersect the plurality of address electrodes 115 formed on the rear substrate 111 perpendicularly thereto with a predetermined gap. A dielectric layer 121 and an MgO protective film 127 are sequentially formed on the display electrodes 117.

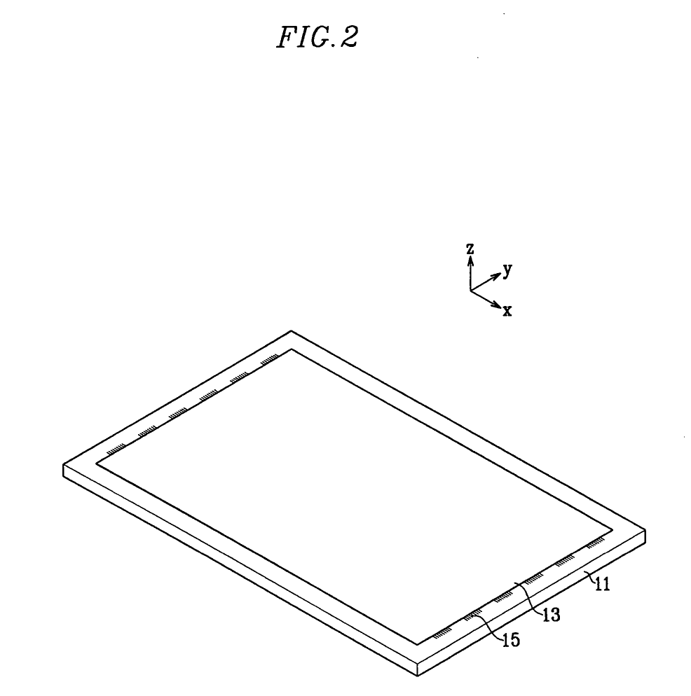

FIG. 2 is a perspective view schematically illustrating the front substrate of the plasma display panel coated with the dielectric layer according to an embodiment of the present invention.

Referring to the figure, in the plasma display panel according to the present embodiment, a plurality of display electrodes 15 extending in a direction (X axis direction in the figure) is formed on a front substrate 11, and a dielectric layer 13 is formed on the display electrodes 15. In the subsequent process, an MgO film (not shown) is formed on the dielectric layer 13, thereby protecting the dielectric layer 13 and also increasing a secondary electron discharging coefficient.

Although not shown, a rear substrate is disposed to correspond to the front substrate 11 of the plasma display panel, and a plurality of address electrodes (not shown) is formed on the surface of the rear substrate opposing the front substrate 11 in a direction (Y axis direction in the figure) intersecting the extending direction of the display electrodes 15.

Pixels are formed at intersections between the address electrodes and the display electrodes 15, and the pixels constitute a display area. That is, the display area can be defined as an area where the address electrodes and the display electrodes 15 intersect each other in a space between the front substrate 11 and the rear substrate and the display discharge can occur due to a driving voltage applied to the electrodes.

Although not shown, a plurality of partition walls dividing the pixels into discharge cells and supporting the front substrate 11 and the rear substrate is formed in the display area, and a fluorescent substance required for generating visible rays is coated in the discharge cells.

As shown in FIG. 2, terminals of the respective electrodes are formed in the portion not covered with the dielectric layer 13, and the terminals are connected to a driving circuit section (not shown) through an electrical connection means such as a flexible printed circuit (FPC), a tape carrier package (TCP), etc. As shown in FIG. 2, the dielectric layer 13 is coated not to cover the terminals of the display electrodes 15 for the purpose of connection to the FPC or the TCP (not shown).

In the plasma display panel according to an embodiment of the present invention, wall charges are formed on the dielectric layer by generating address discharge with the address electrodes in response to driving signals supplied from the display electrodes, and then sustain discharge is generated between a pair of display electrodes in the discharge cells selected by the address discharge according to pulse signals alternately supplied to the display electrodes. Accordingly, ultraviolet rays are generated through excitation and restoration of the discharge gas filled in the discharge spaces constituting the discharge cells, and visible rays are generated through excitation of the fluorescent substance by the ultraviolet rays, thereby forming an image.

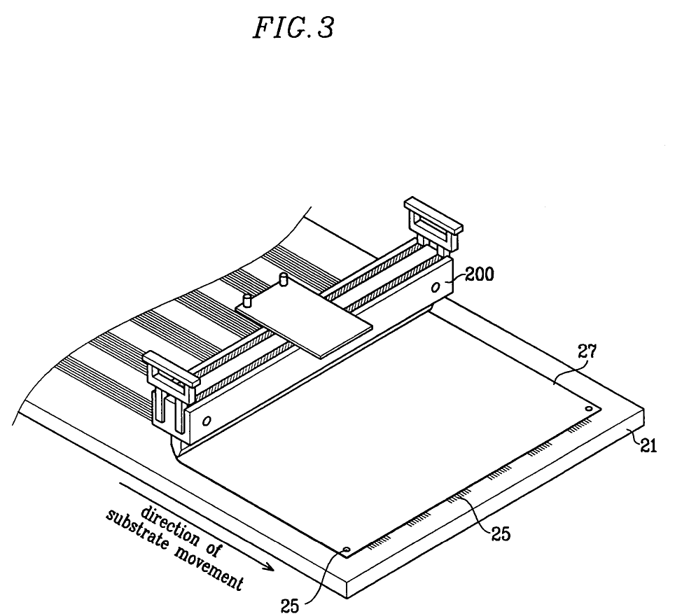

FIG. 3 is a diagram schematically illustrating a step of coating a substrate 21 with dielectric paste 27 using a coater 200 in the method of manufacturing a plasma display panel according to a first embodiment of the present invention. Here, the dielectric layer is formed by applying the dielectric paste 27 not to cover the terminals of electrodes 25. In the step according to the present embodiment, the dielectric paste 27 can be applied while relatively moving the substrate 21 and the coater 200, so that the dielectric paste 27 can be more efficiently applied onto the substrate 21 using the coater 200. The dielectric paste 27 is applied onto the substrate 21 by pushing up the dielectric paste 27 in a head of the coater 200 with a constant pressure and ejecting the dielectric paste 27 through nozzles of the head.

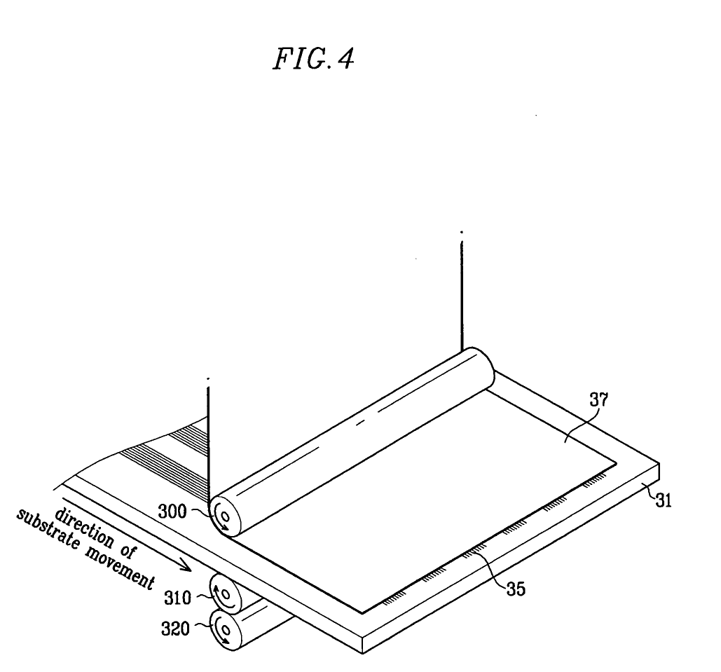

FIG. 4 is a diagram schematically illustrating a step of forming a dielectric layer on a substrate 31 using a lamination sheet on which dielectric paste 37 is printed in the method of manufacturing a plasma display panel according to a second embodiment of the present invention. Here, the dielectric layer is formed by applying the dielectric paste 37 onto the substrate 31 not to cover the terminals of electrodes 35 with the dielectric paste 37 of the lamination sheet. In this case, in order to bond the lamination sheet onto the substrate 31 while moving the substrate 31, driving rollers 300, 310, and 320 are simultaneously driven in the direction indicated by the arrow in FIG. 4.

FIG. 5 is a perspective view schematically illustrating the front substrate of the plasma display panel in which a plurality of plasma display panel units are formed in one substrate according to another embodiment of the present invention.

For example, in the plasma display panel according to the present embodiment shown in FIG. 5, four plasma display panels are formed in one substrate 41. Here, each plasma display panel formed in one substrate is defined as one unit, and each group of electrodes 45 shown in FIG. 5 is defined as one electrode unit. Therefore, the substrate shown in FIG. 5 forms total four plasma display panel units through coupling to a rear substrate. The front substrate itself has four electrode units and a dielectric layer 43 is formed on the four electrode units.

As described above, when a plurality of plasma display panel units are formed from one substrate, the plasma display panels can be manufactured by coating the substrate with the dielectric layer, cutting the substrate into the respective plasma display panel units, bonding the cut plasma display panel units to a rear substrate for a plasma display panel, and chamfering the bonded plasma display panel units. Specifically, as shown in FIG. 5, since the dielectric layer can be formed by continuously applying the dielectric paste to two plasma display panels adjacent to each other, it is possible to manufacture the plasma display panels in mass.

In this way, since the dielectric layer is continuously formed on the plasma display panel units adjacent to each other, the height of the cross-section of the dielectric layer taken perpendicularly to the extending direction of the electrodes is constant in the vicinity of at least one end of the substrate.

In the plasma display panel manufactured in this way, the dielectric layer 43 is formed to extend to at least one circumferential edge of the substrate 41. That is, when the dielectric layer 43 is formed on two panels which will be cut in the subsequent process, the dielectric layer 43 can be formed such that the circumferential edge of the dielectric layer 43 can be approximately matched with the circumferential edge of the substrate.

The number of plasma display panels shown in FIG. 5 is intended to explain the present invention, but the present is not limited to the number. Therefore, the present invention can be applied to a case where the number of plasma display panels is not four.

The plasma display panel shown in FIGS. 2 to 5 is manufactured using the following method.

First, electrodes are formed in one direction on a substrate. This step can be applied to a case where display electrodes are formed on a front substrate of a plasma display panel, and can be also applied to a case where address electrodes are formed on a rear substrate of the plasma display panel. Next, the substrate on which the electrodes are formed is cleaned before application of dielectric paste. After the cleaning, the dielectric paste is applied onto the substrate on which the electrodes are formed. The dielectric paste can be applied using a coater or lamination sheet.

Here, the dielectric paste is obtained by mixing dielectric powders with a binder, and it is preferable that an average diameter of the dielectric powders ranges 0.7 μm to 2.0 μm. In general, when the average diameter of the dielectric powders is small, it is advantageous for sintering. However, when the average diameter of the dielectric powders is less than 0.7 μm, a problem can be caused due to increase in viscosity and aggregation of powders in the course of manufacturing the paste. When the average diameter of the dielectric powders is greater than 2.0 μm, the particles becomes larger, thereby making difficult contraction and contraction and closeness of the dielectric layer. Specifically, when the dielectric paste is baked at a high temperature, the growth of bubbles is accelerated, thereby much decreasing permeability of the dielectric layer. The dielectric paste used in an embodiment of the present invention can be mixed with one or more of PbO, B₂O₃, SiO₂, Al₂O₃, BaO, and ZnO.

After the dielectric paste is applied onto the substrate, the substrate is placed into a dry furnace to dry the dielectric paste. After the dielectric paste is dried, the substrate is placed into a firing furnace to bake the dielectric paste. At the time of firing the dielectric paste, the binder can be removed by firing the dielectric paste at a temperature of 350° C. to 450° C. for 10 to 30 minutes. Next, the dielectric paste may be baked at a temperature of 550° C. to 580° C. for 10 to 30 minutes. As described above, in the method of manufacturing the plasma display panel according to an embodiment of the present invention, the inside of the dielectric layer can be increased in closeness by performing the firing step at a relatively low temperature for a short time.

At the time of forming the dielectric layer, since the bubbles existing in the dielectric paste are merged and expanded with increase in firing time and firing temperature, the permeability of the dielectric substance is decreased. Therefore, in the present invention, by firing the dielectric paste at a relatively low temperature for a short time, generation of the bubbles is suppressed as much as possible. In the conventional screen printing method, when the dielectric paste is applied, the surface roughness of the dielectric layer is bad due to the screen mask. Accordingly, since the surface of the dielectric layer must be leveled through a long-time firing, a lot of bubbles were generated in the dielectric layer. However, in the present invention, by applying the dielectric paste using a coater or a lamination sheet, the surface of the dielectric layer is planarized to some extent. Accordingly, decrease in firing temperature and firing time causes no problem.

In the present invention, it is advantageous that the dielectric layer is formed as a single layer. That is, when the coater or the lamination sheet is used, the thickness of the resultant dielectric layer can be controlled by adjusting the thickness of the dielectric paste to be applied in a range of 80 μm to 120 μm. Accordingly, since the dielectric layer can be formed at a time without performing again the application, dry, and firing of the dielectric paste, it is possible to reduce processing time and processing cost. Therefore, in the present invention, it is possible to obtain a dielectric layer having excellent reliability by performing the printing, drying, and firing processes only once.

In this way, the edge portion of the dielectric layer is clearly formed in a non-stepped shape. Here, the non-stepped shape means that the dielectric layer has a single layer without a stepped portion. Conventionally, since the dielectric layer was formed by performing the application of dielectric paste several times, a stepped portion was formed at the edge portion of the dielectric layer. However, in the present invention, since the dielectric layer is formed by performing the application of dielectric paste only once, the edge portion of the dielectric layer can be formed in a non-stepped shape. Therefore, when the front substrate and the rear substrate of the plasma display panel are bonded by applying frit onto the edge portion of the dielectric layer, the frit can come in close contact with the dielectric layer due to the non-stepped edge portion of the dielectric layer, thereby completely preventing the leakage of discharge gas.

This construction is desirable for the front substrate of the plasma display panel which must have high permeability for generating wall charges. The front substrate of the plasma display panel has the display electrodes and requires insulating ability, smoothness, high permeability, low-bubble ability, and low reactivity with the electrodes. The present invention can satisfy all the requirements.

The above-mentioned embodiment of the present invention will be described in more detail with reference to Experimental examples.

### EXPERIMENTAL EXAMPLE 1

In Experimental example 1, the bubbles existing in the dielectric layer are observed in comparison between the present invention and the conventional art. A dielectric layer is formed on front substrates of a plasma display panel using different steps, the front substrates are cut vertically, and then the cross-sections of the dielectric layers are observed with a scanning electron microscope (SEM).

### First Embodiment

In the first embodiment of the present invention, dielectric paste consisting of SiO₂ of 28.4 wt %, PbO of 69.8 wt %, and B₂O₃ of 1.8 wt % is applied onto a front substrate of a 42-inch plasma display panel on which display electrodes are formed using a coater. Then, the front substrate is dried in a dry furnace at a temperature of 100 to 200° C. for 10 minutes, and is kept in a firing furnace at a temperature of 400° C. for 10 minutes and at a temperature of 550° C. for 10 minutes, thereby forming a dielectric layer.

### COMPARATIVE EXAMPLE

In the comparative example, dielectric paste consisting of SiO₂ of 28.4 wt %, PbO of 69.8 wt %, and B₂O₃ of 1.8 wt % is applied onto a front substrate of a 42-inch plasma display panel on which display electrodes are formed using a screen printing method. Then, the front substrate is dried in a dry furnace at a temperature of 150 to 200° C. for 10 minutes, and is kept in a firing furnace at a temperature of 560° C. to 600° C. for 15 minutes. Then, the above-mentioned processes are repeated once more, thereby forming a dielectric layer.

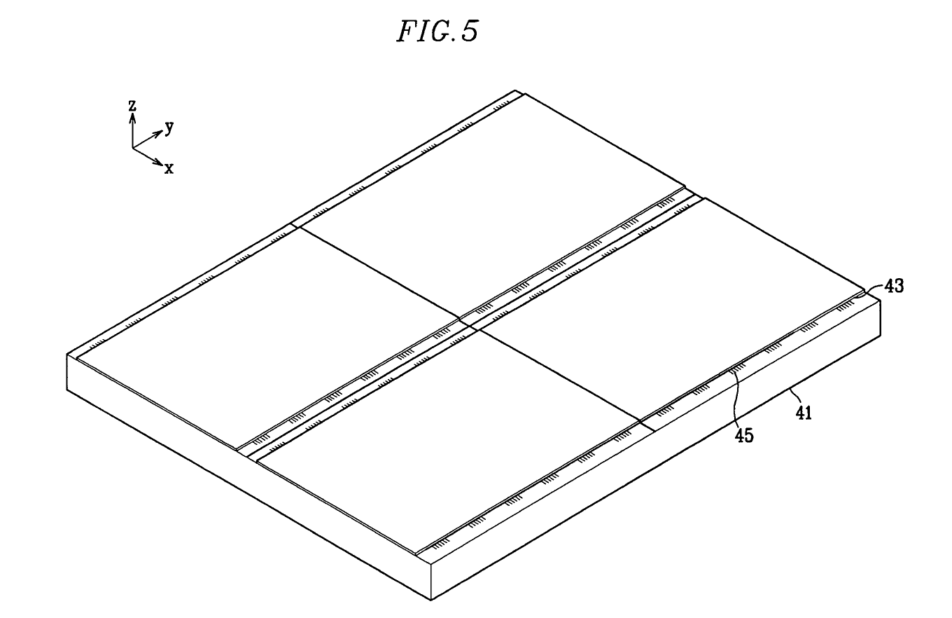

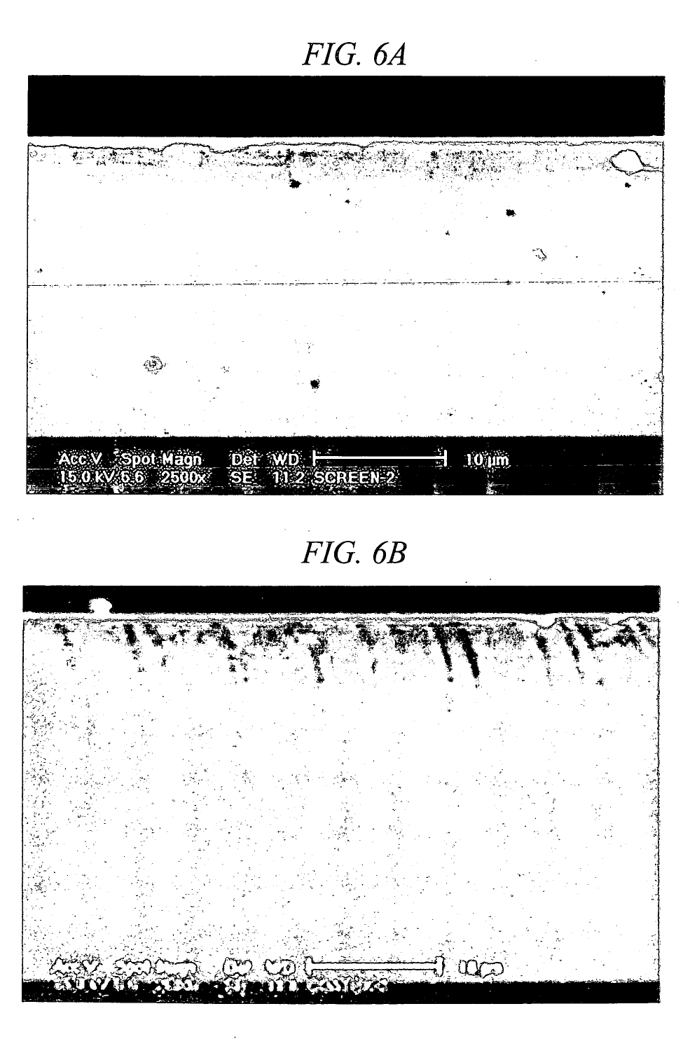

The following result shown in Table 1 is obtained from analysis of the first embodiment of the present invention and the comparative example of the conventional art. The cross-sectional SEM pictures thereof are shown in FIGS. 6A and 6B.

TABLE 1

| | | | Comparative example | |
|---|---|---|---|---|
| | First embodiment | | Two-time printing/drying/ | |
| | One-time printing/drying/ | | firing using a screen | |
| Process condition | firing using a coater | | printing method | |
| Permeability | 69.5% | | 69.0% | |
| Surface roughness | 759.9 | Å | 1518.2 | Å |
| Withstand voltage | 2,121 | V | 1,836 | V |

In Table 1, the permeability is measured with respect to 550 nm. As can be seen from Table 1, the dielectric layer according to the first embodiment of the present invention has more excellent permeability, lower surface roughness, and higher withstand voltage than the dielectric layer according to the comparative example. Therefore, it can be confirmed that characteristics of the dielectric layer according to the first embodiment of the present invention are more excellent than those of the conventional comparative example. The same result can be confirmed from the cross-sectional SEM picture of the dielectric layer according to the embodiment of the present invention shown in FIG. 6A and the cross-sectional SEM picture of the dielectric layer according to the comparative example shown in FIG. 6B. That is, FIG. 6A shows little bubbles in the dielectric layer, but FIG. 6B shows many bubbles in the dielectric layer.

### EXPERIMENTAL EXAMPLE 2

In Experimental example 2, the second embodiment is added in which a dielectric layer is formed using the lamination sheet under the same condition as the first embodiment of Experimental example 1. The dielectric layer is cut and the cross-section in which the dielectric layer and the electrodes are in contact with each other is observed with the scanning electron microscope.

### First Embodiment

The first embodiment is the same as the first embodiment of Experimental example 1.

### Second Embodiment

In the second embodiment of the present invention, a lamination sheet made of dielectric paste consisting of SiO₂ of 28.4 wt %, PbO of 69.8 wt %, and B₂O₃ of 1.8 wt % is applied onto a front substrate of a 42-inch plasma display panel on which display electrodes are formed using a lamination apparatus. Then, the front substrate is dried in a dry furnace at a temperature of 100 to 200° C. for 10 minutes, and is kept in a firing furnace at a temperature of 400° C. for 10 minutes and at a temperature of 550° C. for 10 minutes, thereby forming a dielectric layer.

### COMPARATIVE EXAMPLE

The comparative example is the same as the comparative example of Experimental example 1.

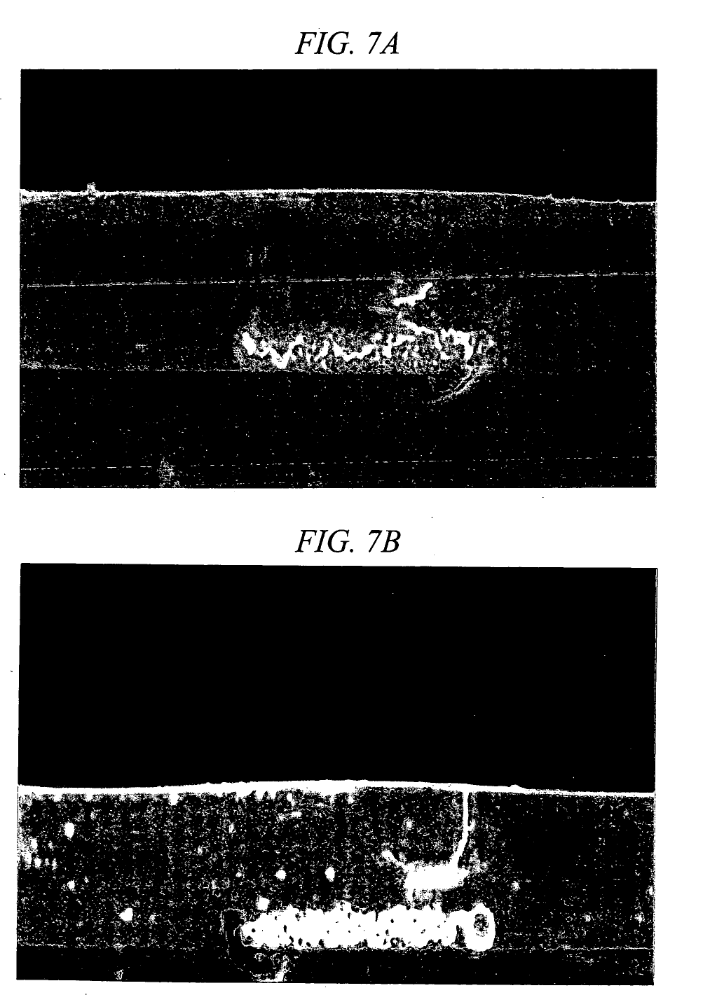

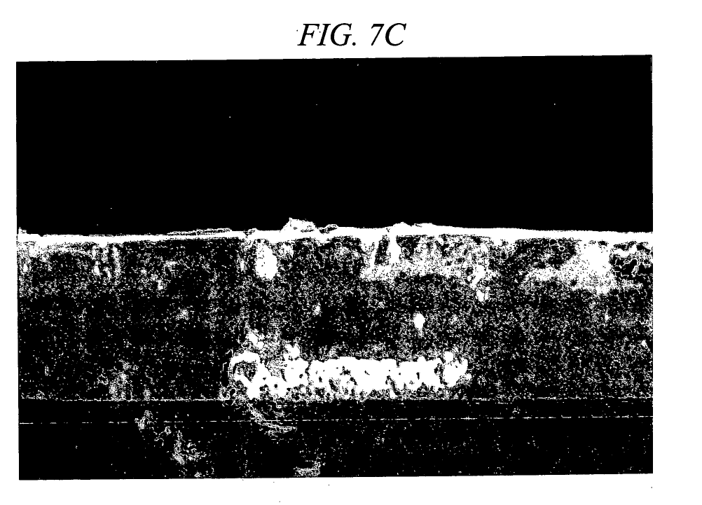

The cross-sectional SEM pictures of the dielectric layers in Experimental example 2 are shown in FIGS. 7A to 7C. FIG. 7A shows a SEM picture in a case where the dielectric layer is formed using a coater according to the first embodiment of the present invention, FIG. 7B shows a SEM picture in a case where the dielectric layer is formed using a lamination sheet according to the second embodiment of the present invention, and FIG. 7C shows a SEM picture in a case where the dielectric layer is formed using a screen printing method according to the comparative example.

As can be seen from FIGS. 7A to 7C, it can be confirmed from FIGS. 7A and 7B that the surface of the dielectric layer is smooth and the internal tissue is homogeneous and close, but it can be confirmed from FIG. 7C that the surface of the dielectric layer is not smooth and the internal tissue is not homogeneous and not close.

Therefore, the method of forming the dielectric layer according to the present invention is more excellent than the conventional method.

As described above, according to the present invention, since the dielectric layer is formed as a single layer, it is possible to largely suppress generation of bubbles, thereby enhancing the permeability of the dielectric layer. As a result, wall charges can be easily generated in the dielectric layer.

In the present invention, since the dielectric paste is applied using the coater or the lamination sheet, the dielectric layer can be formed at a time under while controlling the thickness of the dielectric layer. As a result, it is possible to reduce the processing time and the processing cost.

The present invention can be applied to the front substrate of the plasma display panel on which the display electrodes are formed, so that requirements for the dielectric layer such as insulating ability, smoothness, high permeability, bubble-suppressing ability, and low reactivity with the electrodes can be satisfied.

Since the dielectric layer can be formed continuously at a time in the present invention, the present invention is suitable for forming a plurality of plasma display panels from one substrate. Therefore, it is possible to manufacture the plasma display panels in mass.

Since the dielectric layer can be dried and baked at a low temperature for a short time and the printing, dry, and firing processes are performed at a time, it is possible to reduce the processing time and the processing cost.

Since the edge portion of the dielectric layer is formed in a non-stepped shape, frit can come in close contact with the dielectric layer when the front substrate and the rear substrate are bonded to each other by applying the frit onto the edge portion of the dielectric layer, thereby more completely preventing the leakage of discharge gas.

Although the exemplary embodiments of the present invention have been described, the present invention is not limited to the exemplary embodiments, but may be modified in various forms without departing from the scope of the appended claims, the detailed description, and the accompanying drawings of the present invention. Therefore, it can be understood by those skilled in the art that such modifications belong to the scope of the present invention.

1. A method of manufacturing a plasma display panel, the method comprising the steps of:
forming electrodes in a direction on a substrate;
cleaning the substrate on which the electrodes are formed;
coating the substrate with dielectric paste;
drying the dielectric paste; and
firing the dielectric paste and forming a dielectric layer having a single layer.

2. The method of claim 1, wherein in the step of coating the substrate with the dielectric paste, the dielectric paste is coated using a coater.

3. The method of claim 1, wherein in the step of coating the substrate with the dielectric paste, the dielectric paste is coated in the form of a lamination sheet.

4. The method of claim 1, wherein in the step of forming the electrodes, the electrodes are display electrodes.

5. The method of claim 1, wherein in the step of coating the substrate with the dielectric paste, the dielectric paste contains dielectric powders having an average diameter of 0.7 μm to 2.0 μm.

6. The method of claim 1, wherein the step of forming the dielectric layer includes a step of removing a binder by firing the dielectric paste at a temperature of 350° C. to 450° C. for 10 to 30 minutes.

7. The method of claim 1, wherein in the step of forming the dielectric layer, the dielectric paste is baked at a temperature of 550° C. to 580° C. for 10 to 30 minutes.

8. The method of claim 1, wherein in the step of forming the electrodes, a plurality of electrode units is formed in one substrate.

9. The method of claim 8, further comprising a step of cutting the substrate into respective plasma display panel units, after performing the step of forming the dielectric layer.

10. A plasma display panel, comprising:
a pair of substrates opposing each other;
first electrodes and second electrodes formed on the opposed surfaces of the substrates in directions intersecting each other; and
a dielectric layer formed to cover the first electrodes or the second electrodes,
wherein the dielectric layer extends to an end of an edge of the substrates.

11. The plasma display panel of claim 10, wherein the dielectric layer has a single layer.

12. The plasma display panel of claim 10, wherein the height of a cross-section of the dielectric layer taken perpendicularly to the extending direction of the electrodes is constant in the vicinity of one end of the substrate.

13. The plasma display panel of claim 10, wherein the edge portion of the dielectric layer is formed in a non-stepped shape.
